(19) United States
(12) Patent Application Publication
(10) Pub. No.: US 2026/0348745 A1
(43) Pub. Date: Nov. 5, 2026

(54) MAGNETIC ENCODER

(71) Applicant: MINEBEA MITSUMI Inc., Kitasaku-gun, Nagano (JP)

(72) Inventors: Haruhiro KOMURA, Kitasaku-gun, Nagano (JP); Yu OKAWARA, Kitasaku-gun, Nagano (JP)

(21) Appl. No.: 19/110,561

(22) PCT Filed: Sep. 7, 2023
(86) PCT No.: PCT/JP2023/032644

§ 371 Date: Mar. 11, 2025

(30) Foreign Application Priority Data
Sep. 12, 2022 (JP) 2022-144727

(51) Int. Cl. G01D 5/245; H01F 1/057; H01F 7/02

(52) U.S. Cl. CPC G01D 5/2452; H01F 1/0575; H01F 7/021

(57) ABSTRACT

A magnetic encoder having a ring shape is obtained by mixing and compressing rare earth magnet powder and resin to produce an unheated body and then heating and curing resin contained in the unheated body to produce a heated and cured body, and the magnetic encoder includes a magnetic track magnetized with alternate poles in a circumferential direction at a predetermined magnetic pole pitch. Assuming that a thickness of the unheated body is T (mm), a maximum particle size of the rare earth magnet powder is G (μm), and a ratio R is T/G, the ratio R is 6.67 or greater, and a particle size of the rare earth magnet powder is 45 μm to 150 μm.

### CROSS REFERENCE TO RELATED APPLICATIONS

This application is a national stage entry of International Application No. PCT/JP2023/032644, filed on Sep. 7, 2023, which claims priority to Japanese Patent Application 2022-144727, filed on Sep. 12, 2022, which is incorporated herein by reference.

### TECHNICAL FIELD

The disclosure relates to a magnetic encoder.

### BACKGROUND

Conventionally, a magnetic encoder used for detecting a rotation position of a device is known. As the magnetic encoder, there has been proposed a rotation detection device including a magnetic encoder provided in a concentric ring shape and including two magnetic tracks having different numbers of magnetic poles from each other, and magnetic sensors for detecting magnetic fields of the magnetic tracks, respectively, the rotation detection device being configured to calculate an absolute angle of the magnetic encoder based on a phase difference between magnetic field signals detected by the magnetic sensors (for example, see JP 2008-267867 A).

The magnetic encoder in the rotation detection device of JP 2008-267867 A is configured such that, for example, an elastic member mixed with magnetic powder is vulcanization-bonded to a core metal made of a magnetic body and the elastic member is made into a rubber magnet by alternately forming magnetic poles in a circumferential direction to form magnetic tracks. As another configuration example of the magnetic encoder, it is described that a resin-molded body obtained by molding a resin mixed with magnetic powder may be provided at a core metal made of a magnetic body, and the resin-molded body may be made into a resin magnet by alternately forming magnetic poles in a circumferential direction to form magnetic tracks. In such a rubber magnet and a resin magnet, ferrite magnet powder is usually used as magnetic powder.

In considering the improvement of the magnetic characteristics of the magnetic encoder, preferably, the blending amount of the magnetic body contained in the magnetic encoder is large and the magnetic characteristics of the magnet powder is high. For this reason, the magnetic characteristics is improved more when rare earth magnet powder is used than when ferrite magnet powder is used. Therefore, it is conceivable that the magnetic encoder as a magnetization target object is made of a rare earth bonded magnet.

When a plurality of magnetic poles (N-poles and S-poles) serving as magnetic tracks formed in a magnetic encoder are magnetized, a magnetizing apparatus of a coil energization type (so-called pulse magnetization system) is generally used. For example, the magnetizing apparatus of a coil energization type magnetizes a magnetization target object with a magnetic field caused by applying a pulse current to a field part including a coil wound around a magnetization yoke. However, for example, as described in “Technical Problem” in JP 2017-32327 A, when the magnetic pole width of a magnetic sensor for detecting a magnetic track of a magnetic encoder is limited to 1.28 mm, it is difficult to form a plurality of magnetic poles by saturated magnetization at a narrow magnetic pole pitch such as 1.28 mm by the above-described pulse magnetization system, as compared to a configuration where the magnetic encoder as a magnetization target object is a rare earth bonded magnet.

For this reason, there has been proposed a method capable of suitably magnetizing even in the case of multipolar magnetization by continuously applying a magnetization magnetic field to a magnetization target object by a permanent magnet as a magnetic field source while the magnetization target object is heated to a temperature equal to or higher than the Curie point of the magnet in the magnetization target object and cooled to a temperature lower than the Curie point (for example, see JP 2021-093521 A).

The magnetizing apparatus of JP 2021-093521 A describes an anisotropic rare earth iron-based bulk magnet with anisotropy given by hot-plastic forming magnet powder at a predetermined temperature, an isotropic rare earth iron-based bulk magnet obtained by sintering magnet powder at a predetermined temperature using a spark plasma sintering (SPS) apparatus, an isotropic rare earth iron-based bonded magnet obtained by mixing and compressing isotropic magnet powder and epoxy resin and curing at a predetermined temperature, and an isotropic rare earth iron-based bonded magnet obtained by using isotropic magnet powder, mixing and compressing with epoxy resin, and then curing epoxy resin at a predetermined temperature, and describes that magnetization can be suitably performed even by multipolar magnetization at a narrow magnetic pole pitch such as 1.28 mm.

### SUMMARY

A rare earth bonded magnet is obtained by mixing and compressing a rare earth magnet powder and resin to produce an unheated body as a green body, then heating and curing the resin contained in the green body to produce a heated and cured body as a cured body, and magnetizing the cured body at a predetermined magnetic pole pitch.

However, since the magnet powder contains a mixture of magnet powder having various particle sizes, deformation after heating and curing is likely to occur due to variation in formability when the green body is thinned and density of the green body. In addition, only the magnet powder contributes to magnetic force characteristics, and thus it is important that the magnet powder is evenly distributed in order to increase the accuracy of the magnetic encoder. However, while JP 2021-093521 A describes that the isotropic rare earth iron-based bonded magnet can be suitably magnetized even by multipolar magnetization at a narrow magnetic pole pitch, there is no description about formability when the green body is thinned and deformation after heating and curing, so there is room for further consideration.

The disclosure has been made in view of the above circumstances, and an object is to provide a magnetic encoder with a rare earth bonded magnet capable of improving formability when a green body is thinned and capable of being suitably magnetized even by multipolar magnetization at a narrow magnetic pole pitch with less likeliness of deformation of the green body after heating and curing.

In order to solve the above-described problem and achieve the object, a magnetic encoder according to an aspect of the disclosure is a magnetic encoder having a ring shape and obtained by mixing and compressing rare earth magnet powder and resin to produce an unheated body and then heating and curing resin contained in the unheated body to produce a heated and cured body, the magnetic encoder including a magnetic track magnetized with alternate magnetic poles in a circumferential direction at a predetermined magnetic pole pitch, wherein, assuming that a thickness of the unheated body is T (mm), a maximum particle size of the rare earth magnet powder is G (μm), and a ratio R is T/G, the ratio R is 6.67 or greater, and a particle size of the rare earth magnet powder is 45 μm to 150 μm.

According to the aspect of the disclosure, it is possible to provide a magnetic encoder with ensured formability, less occurrence of deformation after heating and curing, high thickness accuracy, and low profile. Therefore, the magnetic encoder according to the aspect of the disclosure is suitable for detection of angles of joints and motors of various robots, detection of rotation of bearings for vehicles, and the like.

### BRIEF DESCRIPTION OF DRAWINGS

FIG. 1 is a schematic perspective view of a magnetic encoder according to an embodiment.

FIG. 2 is a schematic partial plan view of the magnetic encoder according to the embodiment.

### DESCRIPTION OF EMBODIMENTS

A magnetic encoder according to an embodiment of the disclosure will be described below in detail with reference to the drawings. Note that the present invention is not limited by the embodiment described below.

### Magnetic Encoder According to Embodiment

A magnetic encoder according to an embodiment will be described. From the viewpoint of improving the magnetic characteristics of the magnetic encoder, it is preferable to use an isotropic rare earth bonded magnet for the magnetic encoder. When the rare earth bonded magnet is used, magnetization can be suitably performed even by multipolar magnetization at a narrow magnetic pole pitch, and cost reduction can be expected.

A rare earth bonded magnet is obtained by mixing and compressing rare earth magnet powder and resin to produce a green body as an unheated body, heating and curing resin contained in the green body to produce a cured body as a heated and cured body, and magnetizing the cured body at a predetermined magnetic pole pitch. The rare earth bonded magnet is composed of rare earth magnet powder, resin as a binder, and voids, and the volume ratios of them are about 80% for the rare earth magnet powder, about 10% for the resin, and about 10% for the voids (holes).

Since the rare earth magnet powder contains a mixture of rare earth magnet powder having various particle sizes, deformation after heating and curing is likely to occur due to variations in formability when the green body is thinned and in density of the green body. In addition, only the rare earth magnet powder contributes to magnetic force characteristics, and thus it is important that the rare earth magnet powder is evenly distributed in order to increase the accuracy of the magnetic encoder. The particle size of the rare earth magnet powder does not substantially change between the unheated body, the heated and cured body, and the magnetic encoder after magnetization.

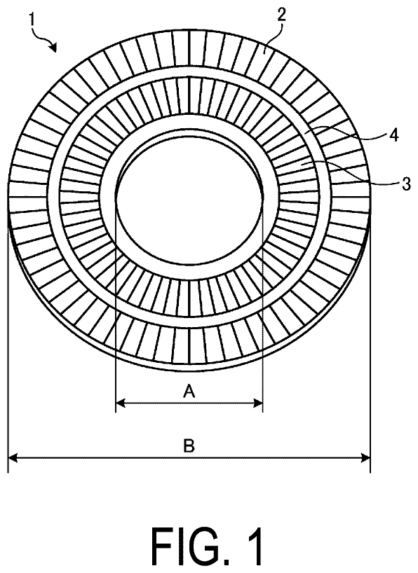

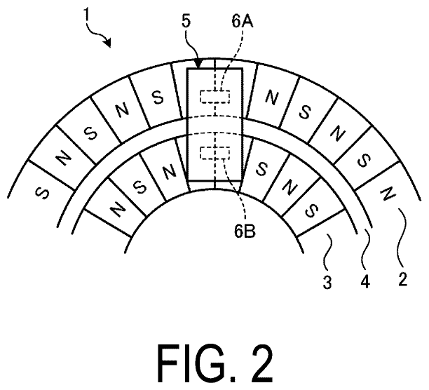

FIG. 1 is a schematic perspective view schematically illustrating the magnetic encoder according to the embodiment, and FIG. 2 is a schematic partial plan view schematically illustrating the magnetic encoder according to the embodiment. As illustrated in FIGS. 1 and 2, a magnetic encoder 1 with a rare earth bonded magnet includes two magnetic tracks, i.e., a main track 2 and an auxiliary track 3, and the main track 2 and the auxiliary track 3 are concentrically arranged at the outer periphery and the inner periphery, respectively, across a non-magnetized region 4.

As illustrated in FIG. 2, each of the main track 2 and the auxiliary track 3 is magnetized such that N poles and S poles are alternately arranged adjacent to each other. In the main track 2 and the auxiliary track 3, a plurality of magnetic pole pairs (N poles and S poles) are magnetized at an equal pitch in the circumferential direction, and the numbers of magnetic poles of the main track 2 and the auxiliary track 3 are different from each other. As illustrated in FIG. 2, a sensor module 5 including magnetic sensors 6A and 6B for detecting the magnetic fields of the main track 2 and the auxiliary track 3, respectively, is disposed on a part of the magnetic poles of the main track 2 and the auxiliary track 3.

When the magnetic encoder 1 is rotated around a concentric center, a phase shift occurs between the magnetic sensor 6A and the magnetic sensor 6B because the number of magnetic poles of the main track 2 and the number of magnetic poles of the auxiliary track 3 are different from each other. By detecting this phase shift and calculating an absolute angle of the magnetic encoder 1, it is possible to detect the rotational position of a device mounted with the magnetic encoder 1.

### Manufacturing of Magnetic Encoder According to Embodiment

In manufacturing the magnetic encoder 1, a rare earth bonded magnet is used because magnetization can be suitably performed even by multipolar magnetization at a narrow magnetic pole pitch and cost reduction can be expected. The rare earth bonded magnet is made of rare earth magnet powder, for example, by a super-rapid cooling method. Specifically, a rare earth alloy is melted by high-frequency induction heating under a reduced pressure or in an argon atmosphere. Subsequently, the molten metal of the melted alloy is sprayed onto a rotating roll made of copper and is subjected to super-rapid cooling (rapid quenching) to produce a ribbon-shaped thin strip. Next, the thin strip is cut into pieces of, for example, about several mm to several tens mm, and then pulverized by a pulverizer or the like to obtain powder.

Next, the pulverized powder is classified using a sieve having a predetermined mesh, and then subjected to heat treatment. Further, rare earth magnet powder and thermosetting resin (epoxy resin) as a binder are mixed at a predetermined compound ratio to prepare a compound. As the predetermined compound ratio, for example, 2 to 3 wt. % of the thermosetting resin is mixed with 97 to 98 wt. % of the rare earth magnet powder. A small amount of a lubricant (e.g., calcium stearate) may be added to the compound. Next, the compound is filled in a mold and compressed by applying a predetermined pressure to produce a green body having a ring shape. The green body taken out from the mold is set in an oven and cured (heated and cured) at a predetermined temperature, for example, about 150 °C for a predetermined time to prepare a cured body.

After the cured body is prepared, a rust-proofing means for preventing oxidation is applied to the surface of the cured body. As the rust-proofing means, a known means such as electrodeposition coating or spray coating is used. After the rust-proofing means is applied to the surface of the cured body, for example, a vernier-type magnetic encoder including two magnetic tracks concentrically formed at one end surface of the cured body in the axial direction is formed, as illustrated in FIG. 2. Specifically, the main track 2 is magnetized at a predetermined magnetic pole pitch at the outer peripheral side, and the auxiliary track 3 is magnetized at a predetermined magnetic pole pitch at the inner peripheral side. Here, the magnetic pole pitch is an interval in the circumferential direction between the adjacent N pole and S pole in each magnetic track.

When the main track 2 is magnetized with n pole pairs, the auxiliary track 3 is magnetized with (n−1) pole pairs. For the magnetic pole pitch, when the magnetic pole widths of the magnetic sensors 6A and 6B for detecting the magnetic tracks of the magnetic encoder 1 are limited, the magnetic pole pitch of the magnetic tracks formed at the magnetic encoder 1 is formed to have the same width as the magnetic pole widths of the magnetic sensors 6A and 6B. For example, when the magnetic pole width of the magnetic sensor 6A is limited to 1.28 mm (or 1.5 mm), the main track 2 of the magnetic encoder 1 as illustrated in FIG. 1 is magnetized to be 1.28 mm (or 1.5 mm).

The magnetization is so-called magnetization, and the magnetizing means is, for example, such that a magnetization magnetic field is continuously applied to a magnetization target object by a permanent magnet as a magnetic field source while the magnetization target object is heated to a temperature equal to or higher than the Curie point of the magnet powder of the magnetization target object and cooled to a temperature lower than the Curie point as disclosed in JP 2021-093521 A, so that magnetization can be suitably performed even by multipolar magnetization at a narrow magnetic pole pitch. Accordingly, the magnetic encoder with the rare earth bonded magnet is manufactured.

### EXAMPLE

Hereinafter, the above-described embodiment will be described in more detail based on examples. The above-described embodiment is not limited by the following Examples and Comparative Examples.

### Example 1 to Example 2 and Comparative Example 1 to Comparative Example 3

Sample 1 to Sample 5 corresponding to Example 1 to Example 2 and Comparative Example 1 to Comparative Example 3 were prepared as the rare earth magnet powder. In each of Sample 1 to Sample 5, Nd—Fe—B-based magnet powder (manufactured by Magnequench International Inc., model number MQP-10-11) as magnetically-isotropic rare earth iron-based magnet powder produced by a super rapid cooling method was used as the rare earth magnet powder.

The rare earth iron-based magnet powder is preferably a magnetically-isotropic rare earth iron-based quenched magnet powder including R₂Fe₁₄B, R₂Fe(Co)₁₄B nanocrystalline having an alloy composition consisting of an R—Fe—B-based magnet (where R represents a rare earth element such as Ce, Pr, Nd, Gd, Tb, Dy, or Ho, including Y) or an R—Fe(Co)—B-based magnet obtained by substituting a part of Fe in the above magnet with Co (where R has the same meaning as above), and further an R—Fe—B-M-based magnet or an R—Fe(Co)—B-M-based magnet using one or a combination of two or more of Si, Al, Nb, Zr, Hf, Mo, Ga, P, and C (where R represents the same meaning as above, and M represents one or a combination of two or more of Si, Al, Nb, Zr, Hf, Mo, Ga, P, and C), and inevitable impurities, or a nanocomposite of αFe, R₂Fe₁₄B, and R₂Fe(Co)₁₄B (wherein R has the same meaning as above).

Alternatively, the rare earth iron-based magnet powder according to the embodiment may be a magnetically-isotropic rare earth iron-based quenched magnet powder including Sm₂Fe₁₇Nₓ (x≈3) nanocrystalline having an alloy composition consisting of a Sm—Fe—N-based magnet, a Sm—Fe-M′-N-based magnet using one or a combination of two or more of Hf, Zr, Si, Nb, Ti, Ga, Al, Ta, and C (where M′ represents one or two or more of Hf, Zr, Si, Nb, Ti, Ga, Al, Ta, and C), and inevitable impurities, or nanocomposite of αFe and Sm₂Fe₁₇Nₓ (x≈3). Further, the above-described R—Fe—B-based magnet powder and Sm—Fe—N-based magnet powder may be mixed, and either or both of them may be magnetically-anisotropic magnet powder.

Next, the rare earth magnet powder of each Sample and thermosetting resin as a binder (epoxy resin manufactured by Pelnox Ltd., model number XW2310) were mixed at a predetermined compound ratio (rare earth magnet powder: 97.5 wt. %, thermosetting resin: 2.5 wt. %) to prepare a compound. The compound ratio of the rare earth magnet powder and the binder was the same for all Samples 1 to 5. A lubricant (e.g., calcium stearate) may be added to the compound. Then, the compound was filled in a mold and compressed by applying a predetermined pressure to prepare a green body (Samples 1 to 5). As illustrated in FIG. 1, the green body has a ring shape with an outer diameter B: Φ56 mm, an inner diameter A: Φ41 mm, and a thickness T: 1.0 mm.

In order to saturation-magnetize the sample, the thickness T of the sample is preferably ½ or more of the magnetic pole pitch. When the thickness T is equal to or greater than ½ of the magnetic pole pitch, the semicircle of the magnetic field lines falls within the sample, and thus a decrease in the magnetic force can be suppressed. For example, as illustrated in FIG. 2, when the magnetic pole width of the magnetic sensor 6A for detecting the magnetic track of the magnetic encoder is limited to 1.28 mm, the magnetic pole pitch of the magnetic track (the main track 2) formed at the magnetic encoder is formed to be 1.28 mm.

For this reason, the thickness T of the sample is not particularly limited as long as it is 0.64 mm or greater, that is, ½ or greater of the magnetic pole pitch of the magnetic track of 1.28 mm. However, when the thickness T of the sample is increased more than necessary, the depth of magnetization at the time of forming the magnetic track becomes insufficient and does not contribute to the magnetic force, so that such a thickness becomes useless and the cost increases. On the other hand, when the thickness T of the sample is about 0.7 mm, although the thickness is ½ or greater of the magnetic pole pitch, for example, the handleability becomes poor, and when the green body compression-molded with a mold is taken out, the green body is highly likely to be broken. In addition, breakage is likely to occur at the time of manual handling, and thus, from the viewpoint of preventing the breakage, the thickness T of the sample was set to 1.0 mm.

Here, the handleability (o: Good without chipping, A: Marginal with some chipping, x: Poor with many chipping) of the green body of each sample was evaluated. The handleability is evaluation of a handling performance when a ring-shaped green body obtained by filling a mold with a compound prepared by mixing rare earth magnet powder and a binder and compression-molding the compound is taken out from the mold, and the handleability was evaluated by visually observing the green body for the occurrence state of cracking or chipping when the green body was taken out from the mold by an ejector pin provided at the mold. The evaluation result of the handleability as well as other evaluation results and the like are summarized and shown in Table 1.

TABLE 1

| | Comparative | Comparative | Comparative | | |
|---|---|---|---|---|---|
| | Example 1 | Example 2 | Example 3 | Example 1 | Example 2 |
| | (Sample 1) | (Sample 2) | (Sample 3) | (Sample 4) | (Sample 5) |
| Maximum particle | 355 | 255 | 225 | 150 | 150 |
| size [μm] | | | | | |
| Minimum particle | 45 | 45 | 45 | 45 | 75 |
| size [μm] | | | | | |
| Presence or | X | X | Δ | ◯ | ◯ |
| absence of | | | | | |
| cracking or | | | | | |
| chipping | | | | | |
| Maximum value − | 0.09 | 0.07 | 0.06 | 0.03 | 0.03 |
| Minimum value | | | | | |
| [mm] | | | | | |
| | X | Δ | ◯ | ◯ | ◯ |
| particle size G | 2.82 | 3.92 | 4.44 | 6.67 | 6.67 |

Next, the green body taken out from the mold was set in an oven and cured (heated and cured) at a temperature of about 150 °C for a predetermined time to prepare a cured body as a heated and cured body. The cured body taken out from the oven was measured for thickness at 8 locations on diagonal lines with a micrometer to evaluate a thickness variation (maximum value-minimum value) and a thickness accuracy, and the evaluation result was shown in Table 1. In Table 1, the sample having a thickness variation value of greater than 0.08 mm was evaluated as unacceptable and the thickness accuracy was denoted by X, the sample having a variation value between 0.08 and 0.06 mm was evaluated as marginal and the thickness accuracy was denoted by A, and the samples having a variation value of less than 0.06 were evaluated as good and the thickness accuracy was denoted by ◯.

From Table 1, in terms of the evaluation of the handleability, in Samples 1 to 3, when the samples (green bodies) were taken out from the mold with the ejector pin, cracking or chipping occurred at outer peripheral edges. In particular, Samples 1 and 2 caused large chipping, and thus were unacceptable. In the case where such chipping reaches a track forming region in magnetizing the sample to form tracks, there is a problem in that the tracks cannot be formed. In addition, Nd—Fe—B-based magnet powder is used as the rare earth magnet powder, and thus is likely to rust. Therefore, in order to prevent oxidation, it is necessary to coat the sample surfaces with an anti-rust film, but the anti-rust film cannot be uniformly formed at locations where the chipping occurs, and there is a concern that rust is generated from these locations. On the other hand, in Samples 4 and 5, no chipping occurred when the samples (green bodies) were taken out from the mold, and the handleability was good.

In addition, in view of the thickness accuracy obtained by evaluating the variation (maximum value-minimum value) in the thickness of the cured body prepared by curing the green body, Samples 1 and 2 had a variation larger than 0.06 mm and were unacceptable, and Samples 3 to 5 had a variation of 0.06 mm or less and were good. In particular, Samples 4 and 5 had a variation of 0.03 mm, showing a good result in the thickness accuracy. When the variation in thickness becomes large, in the case where the sample is used as a magnetic encoder, a variation occurs in the magnitude of the magnetic flux from a track detected by a magnetic sensor for detecting the magnetic track, leading to a decrease in the angle accuracy of the magnetic encoder.

From the evaluation results of the handleability and the thickness accuracy in Table 1, both Samples 4 and 5 showed good results. Here, referring to the maximum particle size in the particle size distribution of the rare earth magnet powder, it can be seen that the maximum particle sizes in Samples 4 and 5 are smaller than the maximum particle sizes in Samples 1 to 3.

Here, assuming that the ratio R between the thickness T (mm) of the green body (Samples 1 to 5) and the maximum particle size G (μm) of the rare earth magnet powder in each of Samples 1 to 5 is T/G, T/G is about 2.82 in Sample 1, about 3.92 in Sample 2, about 4.44 in Sample 3, and about 6.67 in Samples 4 to 5 as shown in Table 1. Therefore, in consideration of the evaluation results of the handleability and the thickness accuracy in Table 1, the thicknesses T of the sample is preferably about 4.5 times or more the maximum particle size of the rare earth magnet powder, and more preferably about 6.7 times or more the maximum particle size of the rare earth magnet powder.

From the evaluation results of the handleability and the thickness accuracy in Table 1, the optimum particle size of the rare earth magnet powder is 45 μm to 225 μm, and preferably 45 μm to 150 μm. When the particle size of the rare earth magnet powder is less than 45 μm, the rare earth magnet powder is likely to be caught in a clearance (gap) between the molds, making it difficult to perform molding. On the other hand, the particle size of the rare earth magnet powder exceeding 150 μm leads to cracking or chipping in the green body, and thus is not preferable.

In the above-described embodiment, a vernier-type axial magnetic encoder with two magnetic tracks concentrically formed at a rare earth bonded magnet having a ring shape has been described, application to a magnetic encoder with one magnetic track is similarly possible. In addition, application to a radial magnetic encoder with a magnetic track formed at the outer peripheral surface of a rare earth bonded magnet having a tubular shape is similarly possible.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A magnetic encoder having a ring shape and obtained by mixing and compressing rare earth magnet powder and resin to produce an unheated body and then heating and curing resin contained in the unheated body to produce a heated and cured body, the magnetic encoder comprising a magnetic track magnetized with alternate poles in a circumferential direction at a predetermined magnetic pole pitch,
wherein, assuming that a thickness of the unheated body is T (mm), a maximum particle size of the rare earth magnet powder is G (μm), and a ratio R is T/G, the ratio R is 6.67 or greater, and a particle size of the rare earth magnet powder is 45 μm to 150 μm.

2. The magnetic encoder according to claim 1, wherein a particle size of the rare earth magnet powder is 75 μm to 150 μm.

3. The magnetic encoder according to claim 1, wherein
the magnetic track includes a main track and an auxiliary track concentrically arranged, and
the main track is located at an outer peripheral side of the auxiliary track across a non-magnetized region.

4. The magnetic encoder according to claim 1, wherein the rare earth magnet powder is rare earth iron-based (Nd—Fe—B-based) magnet powder.

5. The magnetic encoder according to claim 3, wherein the rare earth magnet powder is rare earth iron-based (Nd—Fe—B-based) magnet powder.
